(19) United States
(12) Patent Application Publication
(10) Pub. No.: US 2025/0305767 A1
(43) Pub. Date: Oct. 2, 2025

(54) VERTICAL POWDER SHAKING AND DRYING MACHINE

(71) Applicant: Guangzhou Xin Flying Digital Technology Co., Ltd., Guangzhou (CN)

(72) Inventors: Yijia CHEN, Guangzhou (CN); Zhiwei WEN, Guangzhou (CN); Haibo WANG, Guangzhou (CN); Ke LIU, Guangzhou (CN); Mingbo YAO, Guangzhou (CN)

(73) Assignee: Guangzhou Xin Flying Digital Technology Co., Ltd., Guangzhou (CN)

(21) Appl. No.: 19/091,915

(22) Filed: Mar. 27, 2025

(30) Foreign Application Priority Data
Mar. 29, 2024 (CN) 202420639503.2

(51) Int. Cl. F26B 23/04; B41F 16/00; B41F 23/06

(52) U.S. Cl. CPC F26B 23/04; B41F 16/00; B41F 23/06

(57) ABSTRACT

A vertical powder shaking and drying machine includes a frame, where the frame includes a feeding port provided on one side and a discharging port provided on the other side; a side of the frame close to the discharging port is externally provided with heating hoods; at least one heating hood is at an angle to a horizontal plane; the frame is internally provided with suction plates corresponding to the heating hoods; at least one suction plate is provided along a perpendicular direction; a purification and suction duct is provided above the suction plate; the purification and suction duct is located inside the frame; a side of the frame close to the feeding port is internally provided with a powder shaking box; and the powder shaking box is communicated with the feeding port and located at a front end of the suction plate.

### CROSS-REFERENCE TO THE RELATED APPLICATIONS

This application is based upon and claims priority to Chinese Patent Application No. 202420639503.2, filed on Mar. 29, 2024, the entire contents of which are incorporated herein by reference.

### TECHNICAL FIELD

The present disclosure relates to the field of drying machines, and in particular to a vertical powder shaking and drying machine.

### BACKGROUND

As a type of drying machine, the powder shaking and drying machine is mainly used in the thermal transfer printing process of printing technology. The front end of the powder shaking and drying machine distributes the hot melt adhesive powder onto the surface of a polyethylene terephthalate (PET) film, and the rear end thereof heats the PET film such that the hot melt adhesive powder is melt for the next pressing process.

Most of the existing powder shaking and drying machines are horizontal, with a long drying area and large footprint. As the printed film will shrink due to heat, horizontal drying will cause wrinkles in the printed film, affecting the quality of the pattern. In addition, the powder shaking and drying machine needs an external exhaust fan to discharge exhaust gas generated during drying, so it has high requirements for the usage site. The exhaust gas is prone to leakage at the printed film inlet and outlet, thereby causing environmental pollution.

### SUMMARY

An objective of the present disclosure is to provide a vertical powder shaking and drying machine, in order to solve the problems of large footprint and environmental pollution of existing powder shaking and drying machines.

In order to achieve the objective of the present disclosure, the present disclosure provides a vertical powder shaking and drying machine, including a frame, where the frame includes a feeding port provided on one side and a discharging port provided on the other side; a side of the frame close to the discharging port is externally provided with heating hoods; at least one heating hood is at an angle to a horizontal plane; the frame is internally provided with suction plates corresponding to the heating hoods; at least one suction plate is provided along a perpendicular direction; a purification and suction duct is provided above the suction plate; the purification and suction duct is located inside the frame; a side of the frame close to the feeding port is internally provided with a powder shaking box; the powder shaking box is communicated with the feeding port and located at a front end of the suction plate; and a film retriever is located at a rear end of the discharging port.

As can be seen from the above solution, the powder shaking and drying machine is a vertical powder shaking and drying machine, which saves the horizontal space of the drying area, thereby saving footprint and reducing the requirements for the usage site. Considering that the printed film will shrink when heated, in the vertical drying design, the shrinkage force received by the printed film is counteracted by the gravitational force of pulling, thereby avoiding wrinkles in the printed film and improving product quality. The vertical drying design ensures a compact device while ensuring even drying, saving footprint and reducing site requirements. Meanwhile, the exhaust gas drifts upwards. The perpendicular drying design prevents the risk of exhaust gas leakage from the film inlet and outlet. The top purification and suction channel collects the exhaust gas into the purifier for purification and filtration, preventing environmental pollution.

In a further solution, the powder shaking box is internally provided with a powder feeding assembly and a powder returning assembly; the powder returning assembly includes a powder returning screw, a powder returning groove, a powder storage box, and a powder taking pipe; one end of the powder taking pipe is communicated with the powder storage box; the powder storage box is communicated with the powder returning groove; the other end of the powder taking pipe is communicated with the powder feeding assembly; the powder returning screw is located in the powder returning groove; and the powder feeding assembly is located above the powder returning groove.

As can be seen from the above solution, the powder shaking box is internally provided with the powder feeding assembly and the powder returning assembly. The powder feeding assembly, the powder returning screw, and the powder taking pipe form a circulation system, allowing excess hot melt powder to be recycled. The design eliminates the process of manually adding the hot melt powder, simplifies operation, saves consumables and manpower, and improves efficiency.

In a further solution, one end of the powder returning screw is connected to a powder returning motor; the powder returning motor is configured to drive the powder returning screw to rotate; the powder taking pipe is internally provided with a powder taking screw; one end of the powder taking screw is provided with a powder taking motor; and the powder taking motor is configured to drive the powder taking screw to rotate.

As can be seen from the above solution, the powder feeding and returning operations are driven by the motors, and the design achieves simple and stable structure, convenient operation, high efficiency, no dead corners, low failure rate, and no noise.

In a further solution, the powder feeding assembly includes a powder spreading box; the powder spreading box is internally provided with a powder feeding screw and a powder spreading shaft; the powder spreading shaft is located below the powder feeding screw; and the powder spreading shaft is provided with grooves.

As can be seen from the above solution, the powder spreading shaft and the powder feeding screw are correspondingly arranged. The powder feeding screw sends the powder into the groove of the powder spreading shaft, and the powder spreading shaft rotates to spread the powder onto the printed film. The design achieves even powder spreading, precise control of powder spreading amount, no powder leakage when powder spreading stops, stable and durable structure, and no noise.

In a further solution, there are no less than two grooves; the grooves extend along a length direction of the powder spreading shaft; and the multiple grooves are arranged along a circumference of the powder spreading shaft.

As can be seen from the above solution, the multiple grooves meets the demand for efficient powder spreading.

In a further solution, one end of the powder feeding screw is provided with a powder feeding motor; the powder feeding motor is configured to drive the powder feeding screw to rotate; one end of the powder spreading shaft is provided with a powder spreading motor; and the powder spreading motor is configured to drive the powder spreading shaft to rotate.

As can be seen from the above solution, the powder feeding and spreading operations are driven by the motors, and the design achieves simple, stable structure and convenient operation.

In a further solution, a brush is provided at two sides of the powder spreading shaft; and the brush is fixed to the powder spreading box.

As can be seen from the above solution, the brush is beneficial for spreading the powder out of the groove.

In a further solution, the powder shaking box is further internally provided with a powder tapping assembly; the powder tapping assembly includes a powder tapping plate, a powder tapping shaft, and a powder tapping motor; the powder tapping shaft is externally provided with the powder tapping plate; one end of the powder tapping shaft is connected to the powder tapping motor; and the powder tapping motor is configured to drive the powder tapping shaft to rotate the powder tapping plate.

As can be seen from the above solution, the powder tapping assembly is beneficial for evenly distributing the powder onto the printed film and also for tapping off excess powder on the printed film.

In a further solution, an inner wall of the powder shaking box is provided with a photoelectric sensor; and the photoelectric sensor is located below the powder feeding assembly.

As can be seen from the above solution, the photoelectric sensor is configured to sense the state of the printed film, which can keep the film feeding speed and film retrieval speed consistent.

In a further solution, the powder shaking box is further internally provided with a powder control swing bracket; the powder control swing bracket is located below the powder feeding assembly; the powder control swing bracket includes powder control guide rods, first powder control plates, and an angle sensor; there are two powder control guide rods and two first powder control plates; each of the two first powder control plates passes through two powder control guide rods; one end of one of the powder control guide rods is fixed to the angle sensor; the powder shaking box is provided with a through-hole; and the other powder control guide rod passes through the through-hole and is movable up and down along the through-hole.

As can be seen from the above solution, the above structure is designed to achieve automatic powder control. When the powder is spread onto the printed film, as the amount of the powder increases, the powder control guide rod without the angle sensor moves downward along the through-hole, thereby driving the powder control guide rod with the angle sensor to rotate. When the angle sensor senses a set angle, the powder spreading is stopped. Thus, the design achieves automatic powder control, improving production efficiency, and ensuring the powder spreading effect.

In a further solution, the powder control swing bracket further includes a bottom support and a second powder control plate; the bottom support is hollow; the two first powder control plates are respectively located at two ends of the bottom support; the second powder control plate is located between the two first powder control plates; and the second powder control plate is movable along a length direction of the bottom support.

As can be seen from the above solution, the second powder control plate is suitable for printed films of different lengths, which increases the residence time of powder on the printed film and ensures the powder spreading effect.

In a further solution, a protective net is provided above the powder returning groove.

As can be seen from the above solution, the protective net avoids damage to the printed film caused by the powder returning screw.

In a further solution, an outer side of a surface of the frame is provided with an inspection door; the feeding port is provided with a preheating plate; the surface of the frame is fixedly connected to an operation screen; and the surface of the frame is provided with an acrylic cover plate.

As can be seen from the above solution, the powder feeding and drying parameters can be controlled through the operation screen, achieving full automation and improving production efficiency.

In a further solution, the heating hoods include a first heating hood, a second heating hood, and a third heating hood; the first heating hood is inclined to the horizontal plane; the second heating hood and the third heating hood are perpendicular to the horizontal plane, and the second heating hood is located above the third heating hood; and a locking buckle and a hydraulic rod are connected between the heating hood and the frame.

As can be seen from the above solution, the locking buckle and the hydraulic rod ensure the stability of the connection between the heating hood and the frame, making the heating hood work better.

In a further solution, the suction plate includes a front suction plate and a rear suction plate; the front suction plate corresponds to the first heating hood, and the rear suction plate corresponds to the second heating hood and the third heating hood; and a side of the suction plate facing an interior of the frame is provided with a suction nozzle.

As can be seen from the above solution, the suction nozzle can better adsorb the printed film, prevent it from slipping, and avoid significant displacement and bulging of the printed film.

In a further solution, a connection point between the front suction plate and the rear suction plate is provided with a suction roller shaft; an end of the front suction plate away from the suction roller shaft is provided with a transmission roller shaft; and the suction roller shaft and the transmission roller shaft are provided with a mesh belt.

As can be seen from the above solution, the above structure facilitates the transportation of the printed film.

In a further solution, the frame is further internally provided with a suction fan and a cooling fan.

In a further solution, the frame is further internally provided with a purifier; the purifier includes a purifier centrifuge and an electrical box; and the cooling fan is located at a front end of the film retriever.

As can be seen from the above solution, the cooling fan can achieve good cooling of the printed film, and the purifier is located inside the frame, saving footprint and reducing the requirements for the usage site.

### BRIEF DESCRIPTION OF THE DRAWINGS

FIG. 1 is a structural schematic diagram of a first view of a vertical powder shaking and drying machine according to a first embodiment;

FIG. 2 is a structural schematic diagram of a second view of the vertical powder shaking and drying machine according to the first embodiment;

FIG. 3 is a structural schematic diagram of the vertical powder shaking and drying machine with a side frame hidden according to the first embodiment;

FIG. 4 is a structural schematic diagram of a first view of a powder shaking box according to the first embodiment;

FIG. 5 is a structural schematic diagram of a second view of the powder shaking box with a powder taking pipe hidden according to the first embodiment;

FIG. 6 is a sectional view of the powder shaking box according to the first embodiment;

FIG. 7 is a structural schematic diagram of the vertical powder shaking and drying machine according to a second embodiment;

FIG. 8 is a structural schematic diagram of the vertical powder shaking and drying machine with a side frame hidden according to the second embodiment;

FIG. 9 is a structural schematic diagram of the powder shaking box according to the second embodiment;

FIG. 10 is a sectional view of the powder shaking box according to the second embodiment; and

FIG. 11 is a structural schematic diagram of a powder control swing bracket according to the second embodiment.

The present disclosure is described in further detail below with reference to the drawings and embodiments.

### DETAILED DESCRIPTION OF THE EMBODIMENTS

### First Embodiment

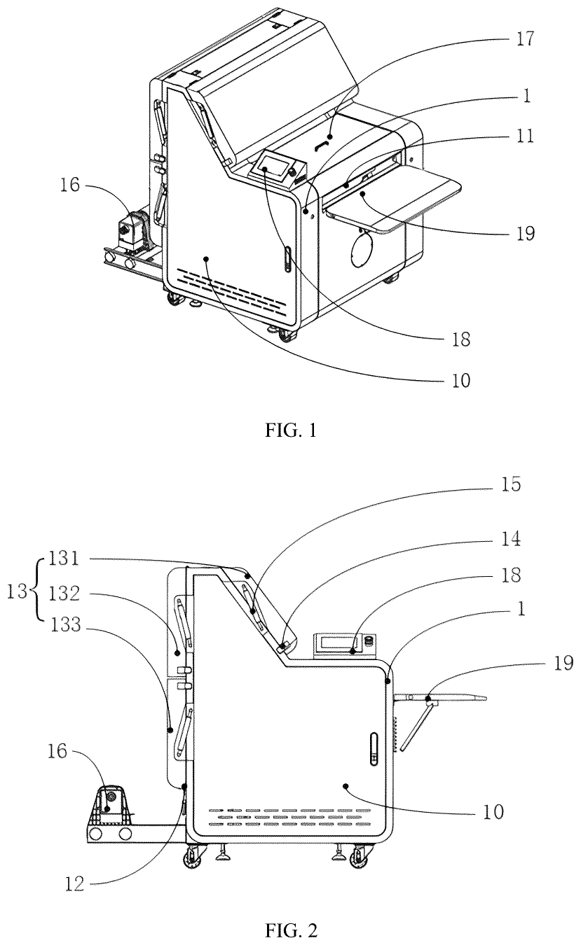

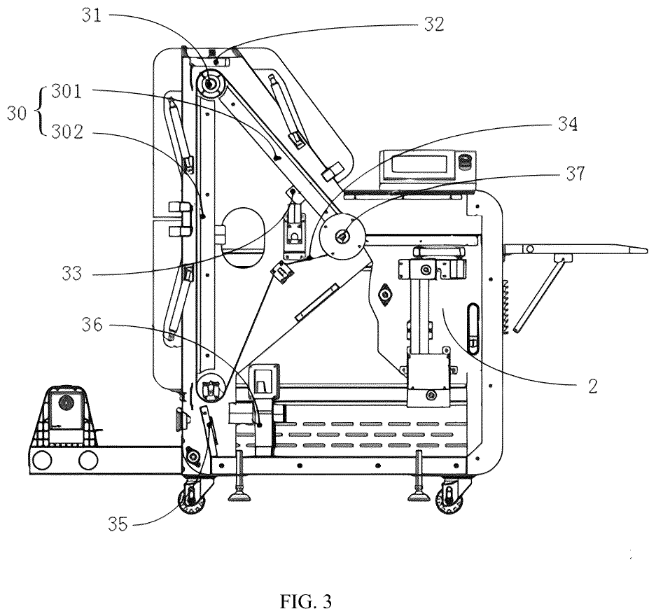

Referring to FIGS. 1 to 6, this embodiment provides a vertical powder shaking and drying machine, including frame 1. The frame 1 includes feeding port 11 provided on one side and discharging port 12 provided on the other side. The feeding port 11 is provided with preheating plate 19. An outer side of a surface of the frame 1 is provided with inspection door 10. The surface of the frame 1 is fixedly connected to operation screen 18. The operation screen 18 is configured to control the entire vertical powder shaking and drying machine. A side of the frame 1 close to the feeding port 11 is internally provided with powder shaking box 2. The powder shaking box 2 is communicated with the feeding port 11.

A side of the frame 1 close to the discharging port 12 is externally provided with heating hoods 13. At least one heating hood 13 is at an angle to a horizontal plane. In this embodiment, there are three heating hoods 13. The heating hoods 13 include first heating hood 131, second heating hood 132, and third heating hood 133. The first heating hood 131 is inclined to the horizontal plane. The second heating hood 132 and the third heating hood 133 are perpendicular to the horizontal plane, and the second heating hood 132 is located above the third heating hood 133. Locking buckle 14 and hydraulic rod 15 are connected between the heating hood 13 and the frame 1. The frame 1 is internally provided with suction plates 30 corresponding to the heating hoods 13. Purification and suction duct 32 is provided above the suction plate 30. The purification and suction duct 32 is located inside the frame 1. The surface of the frame 1 is provided with acrylic cover plate 17.

In this embodiment, the suction plate 30 includes front suction plate 301 and rear suction plate 302. The front suction plate 301 corresponds to the first heating hood 131, and the rear suction plate 302 corresponds to the second heating hood 132 and the third heating hood 133. A side of the suction plate 30 facing an interior of the frame 1 is provided with suction nozzle 33. A connection point between the front suction plate 301 and the rear suction plate 302 is provided with suction roller shaft 31. An end of the front suction plate 301 away from the suction roller shaft 31 is provided with transmission roller shaft 37. The suction roller shaft 31 and the transmission roller shaft 37 are provided with mesh belt 34. The frame 1 is internally provided with mesh belt motor for driving the mesh belt 34 to transport a printed film. The frame 1 is further internally provided with suction fan 36 and cooling fan 35. A side of the frame 1 is fixed to film retriever 16. The powder shaking box 2 is located at a front end of the suction plate 30, and the film retriever 16 is located at a rear end of the discharging port 12.

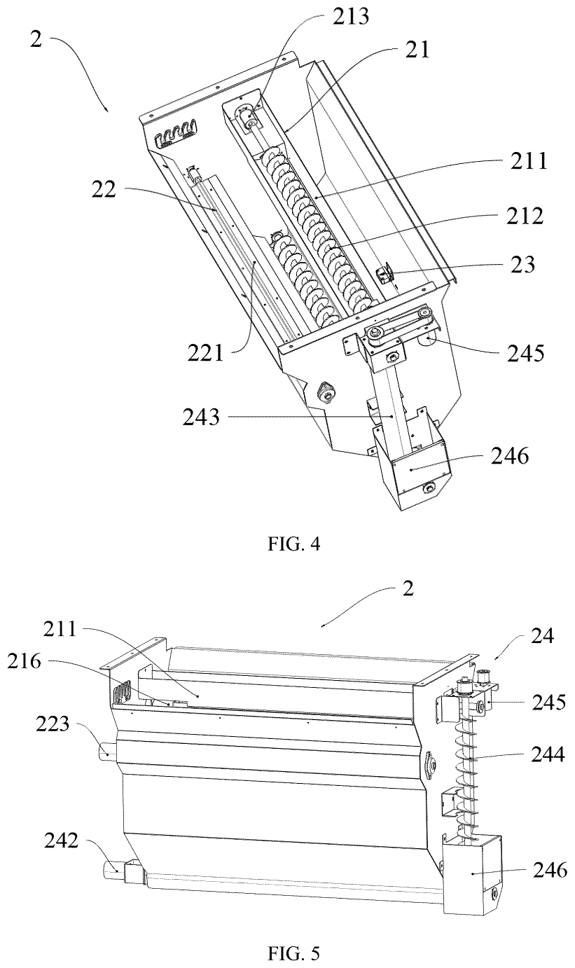

Referring to FIGS. 4 to 6, the powder shaking box 2 is internally provided with powder feeding assembly 21, powder returning assembly 24, powder tapping assembly 22, and photoelectric sensor 23.

The powder feeding assembly 21 includes powder spreading box 211. The powder spreading box 211 is internally provided with powder feeding screw 212 and powder spreading shaft 214. The powder spreading shaft 214 is located below the powder feeding screw 212, and the powder spreading shaft 214 is provided with grooves 2141. There are no less than two grooves 2141. In this embodiment, there are three grooves 2141. The grooves 2141 extend along a length direction of the powder spreading shaft 214, and the multiple grooves 2141 are arranged along a circumference of the powder spreading shaft 241. One end of the powder feeding screw 212 is provided with powder feeding motor 213, and the powder feeding motor 213 drives the powder feeding screw 212 to rotate. One end of the powder spreading shaft 214 is provided with powder spreading motor 216, and the powder spreading motor 216 drives the powder spreading shaft 214 to rotate. Brush 215 is provided at two sides of the powder spreading shaft 214. The brush 215 is fixed to the powder spreading box 211.

The powder returning assembly 24 includes powder returning screw 241, powder returning groove 247, powder storage box 246, and powder taking pipe 243. One end of the powder taking pipe 243 is communicated with the powder storage box 246. The powder storage box 246 is communicated with the powder returning groove 247. The other end of the powder taking pipe 243 is communicated with the powder feeding assembly 21. The powder returning screw 241 is located in the powder returning groove 247. The powder feeding assembly 21 is located above the powder returning groove 247. One end of the powder returning screw 241 is connected to powder returning motor 242. The powder returning motor 242 drives the powder returning screw 241 to rotate. The powder taking pipe 243 is internally provided with powder taking screw 244. One end of the powder taking screw 244 is provided with powder taking motor 245. The powder taking motor 245 drives the powder taking screw 244 to rotate.

The powder tapping assembly 22 includes powder tapping plate 221, powder tapping shaft 222, and powder tapping motor 223. The powder tapping shaft 222 is externally provided with the powder tapping plate 221. One end of the powder tapping shaft 222 is connected to the powder tapping motor 223. The powder tapping motor 223 drives the powder tapping shaft 222 to rotate the powder tapping plate 221.

An inner wall of the powder shaking box 2 is provided with the photoelectric sensor 23. The photoelectric sensor 23 is located below the powder feeding assembly 21.

A working principle of the vertical powder shaking and drying machine in this embodiment is as follows. The printed film enters the powder shaking box 2 after passing through the preheating plate 19. The powder feeding screw 212 delivers a hot melt powder from the powder spreading box 211 to the groove 2141 of the powder spreading shaft 214. The powder spreading shaft 213 rotates to evenly spread the hot melt powder onto the printed film, such that an ink pattern on the printed film is covered with the hot melt powder. The powder tapping plate 221 taps to remove excess hot melt powder. The tapped hot melt powder falls into the powder returning groove 247 at a bottom, and is sent to the powder storage box 246 through the powder returning screw 241. It is then sent back to the powder spreading box 211 through the powder taking screw 244 in the powder taking pipe 243, allowing the excess hot melt powder to be recycled. When the printed film reaches the front suction plate 301, it is adsorbed and sent to a drying area along with the mesh belt 34. Heating tubes in the first heating hood 131, the second heating hood 132, and the third heating hood 133 heat the printed film, allowing ink in the pattern of the printed film to fully fuse with the hot melt powder. Generated exhaust gas enters a purifier through the purification and suction duct 32 at a top to perform purification and filter toxic and harmful substances. When the printed film is sent to the top, it is adsorbed by the suction roller shaft 31. The suction roller shaft 31 rotates to help guide the printed film and prevent it from touching the heating tube. After passing through the suction roller shaft 31, the printed film is adsorbed by the rear suction plate 302 and moves with the mesh belt 34. After leaving the drying area, the printed film becomes dry. At this point, the printed film still has a high residual temperature. After being cooled by the cooling fan 35, the printed film is wound up by the film retriever 16. In order to control the film retrieval speed and real-time film retrieval, the photoelectric sensor 23 is provided inside the powder shaking box. When the photoelectric sensor 23 senses the printed film, the film retriever 16 rotates and retrieves the film, keeping the film feeding speed and retrieval speed consistent.

The vertical powder shaking and drying machine of this embodiment saves the lateral space of the drying area, thereby reducing footprint, lowering requirements for the usage site, avoiding wrinkles in the printed film, and improving product quality. Meanwhile, the exhaust gas drifts upwards. The perpendicular drying design prevents the risk of exhaust gas leakage from the film inlet and outlet. The top purification and suction channel collects the exhaust gas into the purifier for purification and filtration, preventing environmental pollution.

### Second Embodiment

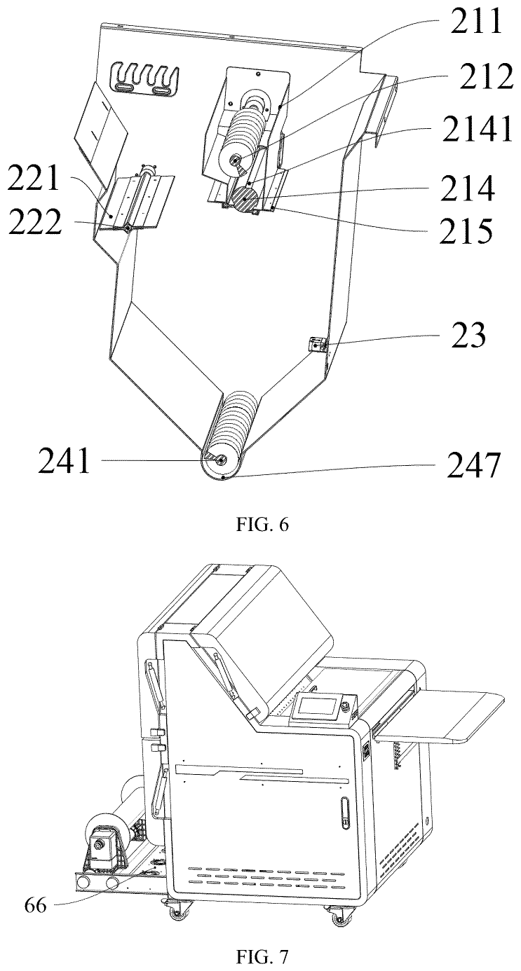

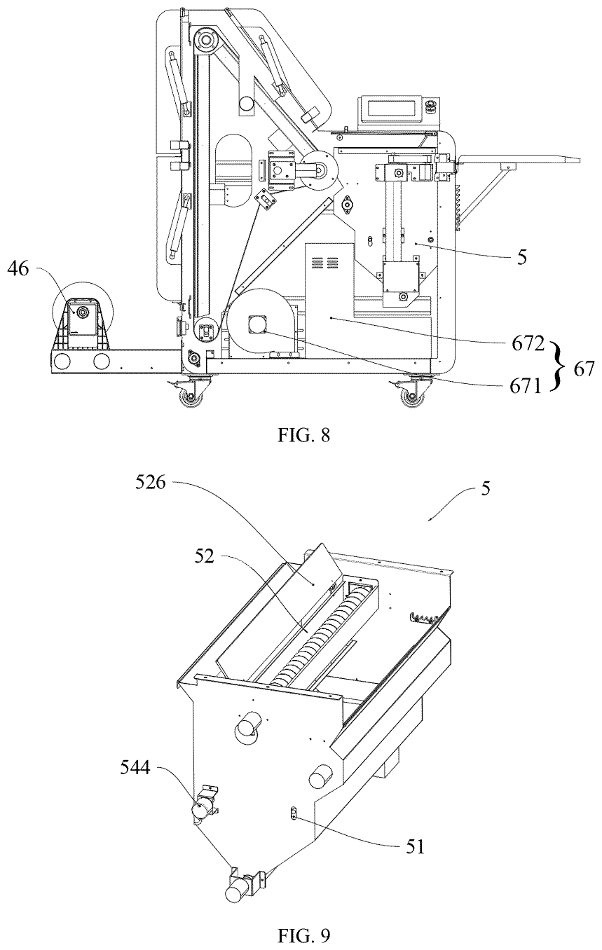

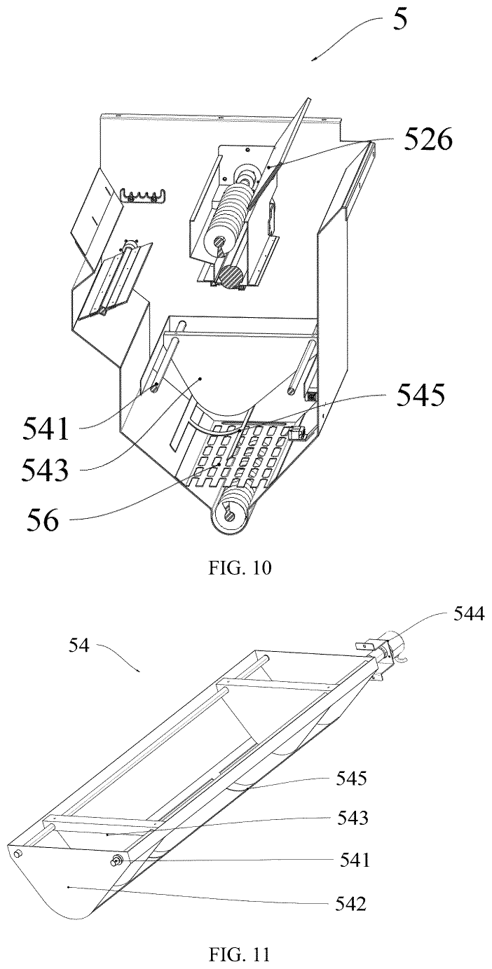

Referring to FIGS. 7 to 11, a vertical powder shaking and drying machine of this embodiment has the same general structure as the vertical powder shaking and drying machine of the first embodiment.

The difference between the vertical powder shaking and drying machine of this embodiment and the vertical powder shaking and drying machine of the first embodiment is as follows. In this embodiment, the frame is further internally provided with purifier 67. The purifier 67 includes purifier centrifuge 671 and electrical box 672. The purifier centrifuge 671 and the electrical box 672 are both located within the frame. The cooling fan 66 is located at a front end of the film retriever 46 and is located outside the frame.

In addition, the powder shaking box 5 of this embodiment is further internally provided with powder control swing bracket 54. The powder control swing bracket 54 is located below the powder feeding assembly. The powder control swing bracket 54 includes powder control guide rods 541, first powder control plates 542, second powder control plates 543, bottom support 545, and angle sensor 544. There are two powder control guide rods 541 and two first powder control plates 542. Each of the two first powder control plates 542 passes through two powder control guide rods 541. One end of one of the powder control guide rods 541 is fixed to the angle sensor 542. The powder shaking box 5 is provided with through-hole 51. The other powder control guide rod 541 passes through the through-hole 51 and is movable up and down along the through-hole 51. The bottom support 545 is hollow. The two first powder control plates 542 are respectively located at two ends of the bottom support 545. The second powder control plates 543 are located between the two first powder control plates 542. There are two second powder control plates 543. The second powder control plates 543 are movable along a length direction of the bottom support 545. Protective net 56 is provided above the powder returning groove.

The powder control swing bracket 54 is additionally provided. The hot melt powder is spread onto the printed film by a powder spreading roller shaft. As the amount of the hot melt powder increases, the powder control guide rod 541 without the angle sensor 544 moves downward along the through-hole 51, thereby driving the powder control guide rod 541 with the angle sensor 544 to rotate. When the angle sensor 544 senses a set angle, it transmits a signal to stop powder spreading. Thus, the design achieves automatic powder control, improving production efficiency, and ensuring the powder spreading effect. The protective net 56 can prevent damage to the printed film caused by the powder returning screw.

Finally, it should be emphasized that the above described are only preferred embodiments of the present disclosure and are not intended to limit the present disclosure. For those skilled in the art, various changes and modifications may be made to the present disclosure, but any modifications, equivalent replacements and improvements made within the spirit and principle of the present disclosure should be included in the protection scope of the present disclosure.

What is claimed is:

1. A vertical powder shaking and drying machine, comprising a frame, wherein the frame comprises a feeding port provided on a first side and a discharging port provided on a second side;
a side of the frame adjacent to the discharging port is externally provided with heating hoods; at least one heating hood is at an angle to a horizontal plane; the frame is internally provided with suction plates corresponding to the heating hoods; at least one suction plate is provided along a perpendicular direction; a purification and suction duct is provided above the suction plate; and the purification and suction duct is located inside the frame;
a side of the frame adjacent to the feeding port is internally provided with a powder shaking box; and the powder shaking box is communicated with the feeding port and located at a front end of the suction plate; and
a film retriever is located at a rear end of the discharging port.

2. The vertical powder shaking and drying machine according to claim 1, wherein
the powder shaking box is internally provided with a powder feeding assembly and a powder returning assembly; the powder returning assembly comprises a powder returning screw, a powder returning groove, a powder storage box, and a powder taking pipe; a first end of the powder taking pipe is communicated with the powder storage box; the powder storage box is communicated with the powder returning groove; a second end of the powder taking pipe is communicated with the powder feeding assembly; the powder returning screw is located in the powder returning groove; and the powder feeding assembly is located above the powder returning groove.

3. The vertical powder shaking and drying machine according to claim 2, wherein
an end of the powder returning screw is connected to a powder returning motor; and the powder returning motor is configured to drive the powder returning screw to rotate; and
the powder taking pipe is internally provided with a powder taking screw; an end of the powder taking screw is provided with a powder taking motor; and the powder taking motor is configured to drive the powder taking screw to rotate.

4. The vertical powder shaking and drying machine according to claim 2, wherein
the powder feeding assembly comprises a powder spreading box; the powder spreading box is internally provided with a powder feeding screw and a powder spreading shaft; the powder spreading shaft is located below the powder feeding screw; and the powder spreading shaft is provided with grooves.

5. The vertical powder shaking and drying machine according to claim 4, wherein
there are at least two grooves; the at least two grooves extend along a length direction of the powder spreading shaft; and the at least two grooves are arranged along a circumference of the powder spreading shaft.

6. The vertical powder shaking and drying machine according to claim 4, wherein
an end of the powder feeding screw is provided with a powder feeding motor; and the powder feeding motor is configured to drive the powder feeding screw to rotate; and
an end of the powder spreading shaft is provided with a powder spreading motor; and the powder spreading motor is configured to drive the powder spreading shaft to rotate.

7. The vertical powder shaking and drying machine according to claim 4, wherein
a brush is provided at two sides of the powder spreading shaft; and the brush is fixed to the powder spreading box.

8. The vertical powder shaking and drying machine according to claim 2, wherein
the powder shaking box is further internally provided with a powder tapping assembly; the powder tapping assembly comprises a powder tapping plate, a powder tapping shaft, and a powder tapping motor; the powder tapping shaft is externally provided with the powder tapping plate; an end of the powder tapping shaft is connected to the powder tapping motor; and the powder tapping motor is configured to drive the powder tapping shaft to rotate the powder tapping plate.

9. The vertical powder shaking and drying machine according to claim 2, wherein
an inner wall of the powder shaking box is provided with a photoelectric sensor; and the photoelectric sensor is located below the powder feeding assembly.

10. The vertical powder shaking and drying machine according to claim 2, wherein
the powder shaking box is further internally provided with a powder control swing bracket; and the powder control swing bracket is located below the powder feeding assembly;
the powder control swing bracket comprises powder control guide rods, first powder control plates, and an angle sensor; there are two powder control guide rods and two first powder control plates; and each of the two first powder control plates passes through the two powder control guide rods; and
an end of a first one of the two powder control guide rods is fixed to the angle sensor; the powder shaking box is provided with a through-hole; and a second one of the two powder control guide rods passes through the through-hole and is movable up and down along the through-hole.

11. The vertical powder shaking and drying machine according to claim 10, wherein
the powder control swing bracket further comprises a bottom support and a second powder control plate; the bottom support is hollow; the two first powder control plates are respectively located at two ends of the bottom support; the second powder control plate is located between the two first powder control plates; and the second powder control plate is movable along a length direction of the bottom support.

12. The vertical powder shaking and drying machine according to claim 2, wherein
a protective net is provided above the powder returning groove.

13. The vertical powder shaking and drying machine according to claim 1, wherein
an outer side of a surface of the frame is provided with an inspection door; the feeding port is provided with a preheating plate; the surface of the frame is fixedly connected to an operation screen; and the surface of the frame is provided with an acrylic cover plate.

14. The vertical powder shaking and drying machine according to claim 1, wherein
the heating hoods comprise a first heating hood, a second heating hood, and a third heating hood; the first heating hood is inclined to the horizontal plane; the second heating hood and the third heating hood are perpendicular to the horizontal plane, and the second heating hood is located above the third heating hood; and
a locking buckle and a hydraulic rod are connected between the heating hood and the frame.

15. The vertical powder shaking and drying machine according to claim 14, wherein
the suction plate comprises a front suction plate and a rear suction plate; the front suction plate corresponds to the first heating hood, and the rear suction plate corresponds to the second heating hood and the third heating hood; and
a side of the suction plate facing an interior of the frame is provided with a suction nozzle.

16. The vertical powder shaking and drying machine according to claim 15, wherein
a connection point between the front suction plate and the rear suction plate is provided with a suction roller shaft; an end of the front suction plate away from the suction roller shaft is provided with a transmission roller shaft; and the suction roller shaft and the transmission roller shaft are provided with a mesh belt.

17. The vertical powder shaking and drying machine according to claim 1, wherein
the frame is further internally provided with a suction fan and a cooling fan.

18. The vertical powder shaking and drying machine according to claim 1, wherein
the frame is further internally provided with a purifier; and the purifier comprises a purifier centrifuge and an electrical box; and
a cooling fan is located at a front end of the film retriever.
